(19) United States
(12) Patent Application Publication
(10) Pub. No.: US 2009/0003385 A1
(43) Pub. Date: Jan. 1, 2009

(54) TX EVM IMPROVEMENT OF OFDM COMMUNICATION SYSTEM

(75) Inventor: Mau-Lin Wu, Hsinchu City (TW)

Correspondence Address: J C PATENTS, INC., 4 VENTURE, SUITE 250, IRVINE, CA, 92618, US

(73) Assignee: FARADAY TECHNOLOGY CORP., Hsinchu (TW)

(21) Appl. No.: 11/769,996

(22) Filed: Jun. 28, 2007

(51) Int. Cl. H04B 3/10

(52) U.S. Cl. 370/491

(57) ABSTRACT

In a wireless communication method and system, a data/pilot constellation is modulated and generated based on input information bits. Channel estimation (CE) sequence in frequency-domain is off-line generated. The frequency-domain channel estimation sequence is transformed into a time-domain channel estimation sequence by ideal IFFT to avoid IFFT (Inverse Fast Fourier Transform) impact to EVM (Error Vector Magnitude) performance. Off-line resealing the time-domain CE sequence, multiplied by a rescaling coefficient, in time-domain improves EVM performance. Further, the time-domain channel estimation sequence is off-line quantized.

### BACKGROUND OF THE INVENTION

1. Field of Invention

The present invention relates to an improvement of a communication system. More particularly, the present invention relates to an improvement of a communication system featured with generation of training sequences in time-domain and off-line rescaling of the training sequences.

2. Description of Related Art

With the progress of broadband communication, communication methods using sub-carrier modulation, such as Wideband Code Division Multiple Access (WCDMA), Orthogonal Frequency Division Multiplexing (OFDM), and multi-carrier versions of Global Standard for Mobile Communication (GSM) and Code Division Multiple Access 2000 (CDMA 2000), have come to be used and high efficiency. OFDM is a multi-channel modulation system employing Frequency Division Multiplexing (FDM) of orthogonal sub-carriers, each modulating a low bit-rate digital stream.

In OFDM systems, transmitters and receivers communicate through wireless propagation “channels.” The transmitted waveforms are reflected by scatterers present in the wireless media, and arrive at the receiver via many different paths. The multi-path wireless channel causes interference between the transmitted data symbols, referred to as inter-symbol interference (ISI).

In order to recover the transmitted sequence, the receiver estimates and compensates for the channel effects induced by the wireless communication channel. The channel is characterized either in the time-domain via its impulse response (the channel output when the input is an impulse), or in the frequency domain via its frequency response (the channel output when the input is a complex exponential with certain frequency). Techniques for estimating the channel's impulse or frequency response are generally referred to as data-aided, blind, or, semi-blind. In data-aided techniques, the transmitter sends a training sequence that is known by the receiver. The receiver can then estimate the impulse response of the channel by comparing the received data, i.e., the output of the channel, with the training sequence.

In addition, the receiver must identify the start of a packet or frame (time synchronization), adjust for offsets in sampling phase and carrier frequency (frequency synchronization), and equalize for the channel impulse response (channel equalization). Inaccurate synchronization leads to inter-symbol interference (ISI) or inter-carrier interference (ICI), both of which degrade the overall bit error rate (BER) performance of the system. Errors in channel estimation also lead to BER degradation.

Besides, guard band symbols of zero level and pilot symbols are also required. The guard band symbols are used to help contain the spectrum of the signal within the spectrum that is allowed for the system. The system pilot symbols are interspersed with user data symbols.

Data transmitted over OFDM symbol carriers may be encoded and modulated in amplitude and/or phase, using conventional schemes such as Binary Phase Shift Key (BPSK) or Quadrature Phase Shift Key (QPSK).

In OFDM communication system, a well-known training sequence, i.e. channel estimation (CE) sequence, is included in the packet for channel impulse response estimation. The estimation of channel impulse response will be applied to compensate the channel impulse response by the equalizer. Another special feature for OFDM communication system is that the equalization can be easily applied at frequency domain, rather than at time-domain. This is due to the “circular convolution” property of the OFDM communication system. Equalization can be easily performed at frequency domain by dividing the received sub-carrier constellation based on estimation of channel response of each sub-carrier.

Due to “equalization” is performed at frequency-domain, the “CE” sequence is conventionally designed or generated at frequency domain, instead of at time-domain. In general case, “CE” sequence is designed as pre-defined constellation, which has the same modulation as information bit. In conventional generation of “CE” sequence, it's intuitive to generate “CE” sequence at frequency domain according to the standard and transform to time-domain by IFFT (Inverse Fast Fourier Transform) at transmission (TX) side. One of the popular performance indices to measure the implementation loss of TX side is Error Vector Magnitude (EVM) test.

There are several drawbacks for “frequency-domain” implementation of “CE” sequence. The first drawback is that the accuracy of “CE” sequence is not enough and is degraded due to “implementation loss” of IFFT. Performance degradation of “CE” sequence is critical to TX EVM performance. The second drawback is that it's difficult to rescale “CE” sequence on-purpose to improve TX EVM performance. For the condition that modulation schemes at information bits are different from that at “CE” sequence, EVM of data-subcarriers with different modulations will have extra loss. The third drawback is that EVM of CE constellation degrades TX EVM of data/pilot subcarriers.

It is preferred that the above drawbacks of the state of the art are solved. Generation of “CE” sequence at frequency-domain and transformation into time-domain may avoid IFFT's impact on EVM performance. Rescaling “CE” sequence at time-domain also improves EVM performance for each and every specific data rates, which use different modulation schemes.

### SUMMARY OF THE INVENTION

The invention is to provide a communication system and method for improving the accuracy of “CE” sequence and TX EVM by generation of “CE” sequence at time-domain.

The invention is to provide a communication system and method for avoiding impact from IFFT implementation loss and improving TX EVM by generation of “CE” sequence at time-domain.

The invention is to provide a communication system and method for improving TX EVM performance by rescaling “CE” sequence for different modulation scheme.

One example of the invention provides a wireless communication method, comprising: (a) modulating and generating a data/pilot constellation based on input information bits; (b) off-line generating a channel estimation sequence in frequency-domain; (c) off-line transforming the frequency-domain channel estimation sequence into a time-domain channel estimation sequence by “ideal” IFFT function; (d) based on a predetermined resealing coefficient, off-line resealing the time-domain channel estimation sequence; and (e) off-line quantizing the time-domain channel estimation sequence.

Another example of the invention provides a transmitter for a communication system, comprising: a channel estimation constellation mapping module, for off-line generating a channel estimation sequence in frequency-domain; a first transforming module, for off-line and ideally transforming the frequency-domain channel estimation sequence from the channel estimation constellation mapping module into a time-domain channel estimation sequence; a resealing module, for off-line resealing the time-domain channel estimation sequence from the first transforming module based on a predetermined resealing coefficient, for improving error vector magnitude (EVM) thereof; and a first quantization module, for off-line quantizing the time-domain channel estimation sequence from the resealing module.

Still another example of the invention provides a communication system, comprising: a data/pilot constellation mapping module, for modulating and generating a data/pilot constellation; a first quantization module, for quantizing the data/pilot constellation from the data/pilot constellation mapping module; a first transforming module, for transforming the data/pilot constellation output from the first quantization module; a channel estimation constellation mapping module, for off-line generating a channel estimation sequence in frequency-domain; a second transforming module, for off-line and ideally transforming the frequency-domain channel estimation sequence from the channel estimation constellation mapping module into a time-domain channel estimation sequence; a resealing module, for off-line resealing the time-domain channel estimation sequence from the second transforming module; and a second quantization module, for off-line quantizing the time-domain channel estimation sequence from the resealing module.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows a basic block diagram of an OFDM communication system.

FIG. 2 shows a part of a conventional frequency-domain CE generation.

FIG. 3 shows EVM and constellation of “CE” by this conventional art.

FIG. 4 shows EVM and constellation for DCM modulation by the conventional art.

FIG. 5 shows a block diagram of a transmitter in the OFDM communication system according to an embodiment of the invention.

FIG. 6 shows EVM and constellation plot of the time-domain “CE” sequence according to the embodiment of the invention.

FIG. 7 shows EVM and constellation plot of DCM by the time-domain “CE” sequence and resealing according to the embodiment of the invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

In this embodiment, “Multiband OFDM Pyhsical Layer Specification”, Release 1.1, WiMedia Alliance, Jul. 14, 2005 (hereinafter “WiMedia UWB PHY”) is taken as an example.

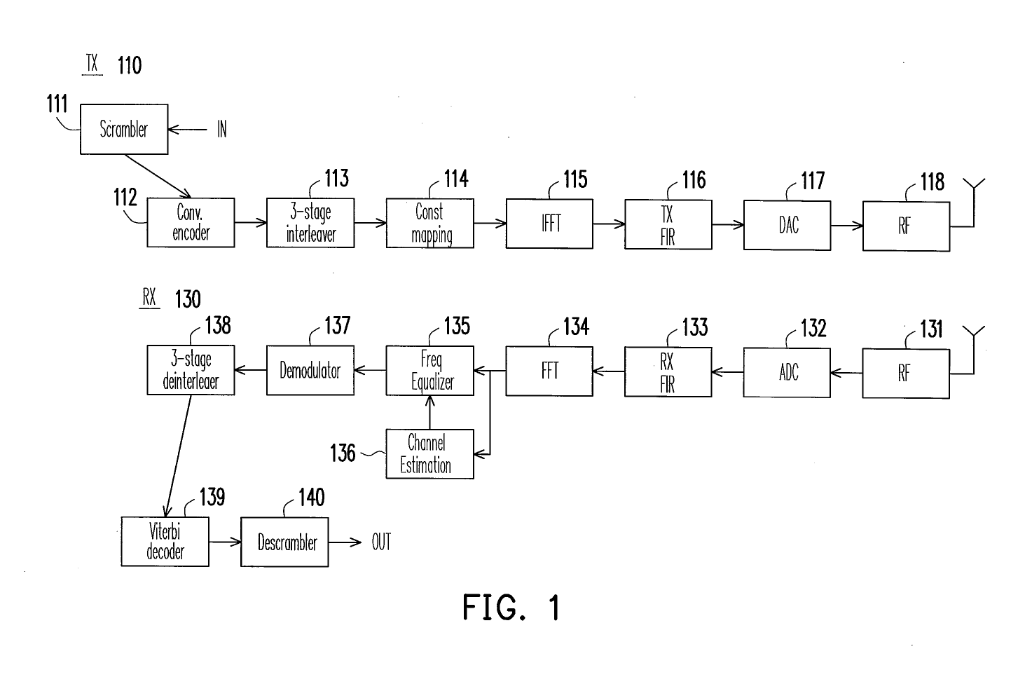

In FIG. 1, a basic block diagram of an OFDM communication system is shown. The OFDM communication system includes a transmitter (TX) 110 and a receiver (RX) 130. The transmitter 110 includes a scrambler 111, a convolution encoder 112, a 3-stage interleaver 113, a constellation mapping module (or modulator) 114, an IFFT (Inverse Fast Fourier Transform) module 115, a transmission FIR (Finite Impulse Response) filter 116, a digital-to-analog converter (DAC) 117 and a radio frequency (RF) module 118. The receiver 130 includes an RF module 131, an analog-to-digital converter (ADC) 132, a RX FIR filter 133, a Fast Fourier Transform (FFT) module 134, a frequency equalizer 135, a channel estimation module 136, a demodulator 137, a 3-stage de-interleaver 138, a Viterbi decoder 139 and a descrambler 140. The channel estimation module 136 and the frequency equalizer 135 are for equalization. Further, the channel estimation module 136 and the frequency equalizer 135 are of “one-tape frequency-domain equalization”. In FIG. 1, “IN” refers to input information bits while “OUT” refers to output information bits.

The scrambler 111 is for scrambling the input information bits IN. The convolution encoder 112 is for encoding the scrambled information bits from the scrambler 111. The 3-stage interleaver 113 is for interleaving the encoded information bits from the convolution encoder 112. The constellation mapping module 114 is for modulating the interleaved information bits from the 3-stage interleaver 113. The IFFT module 115 is for IFFT-ing the modulated information bits from the constellation mapping module 114. The transmission FIR filter 116 is for filtering the IFFT-ed information bits from the IFFT module 115. The DAC 117 converts the filtered information bits from the transmission FIR filter 116 and the RF module 118 sends out the converted information bits to the receiver 130 via wireless channel (for example, air).

The composing elements in the receiver 130 basically perform inverse operation of the composing elements in the transmitter 110. Therefore, the operation of the composing elements in the receiver 130 is omitted here for simplicity.

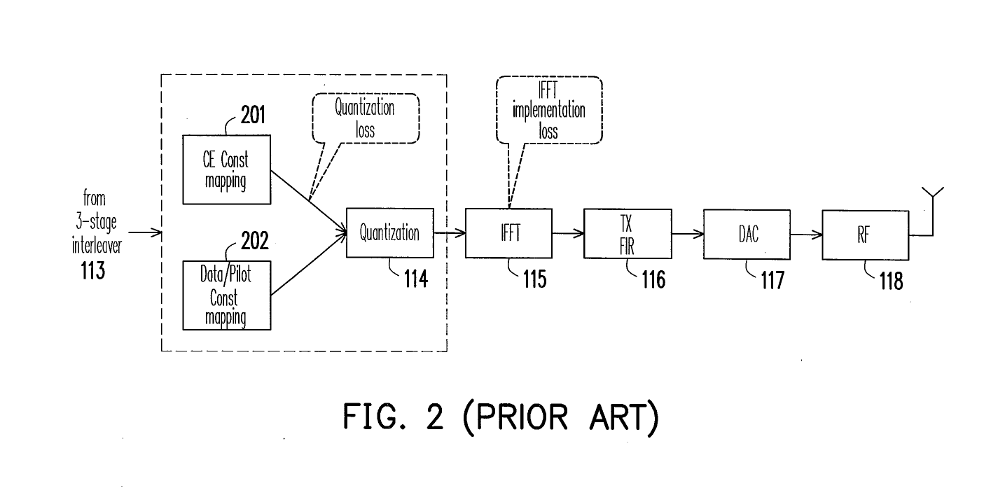

In data-aided techniques, CE sequence is generated and included in the packet sent to the receiver 130. FIG. 2 shows a part of a conventional frequency-domain CE generation. As shown in FIG. 2, the constellation mapping module 114 includes a CE constellation mapping module 201, a data/pilot constellation mapping module 202 and a quantization module 203.

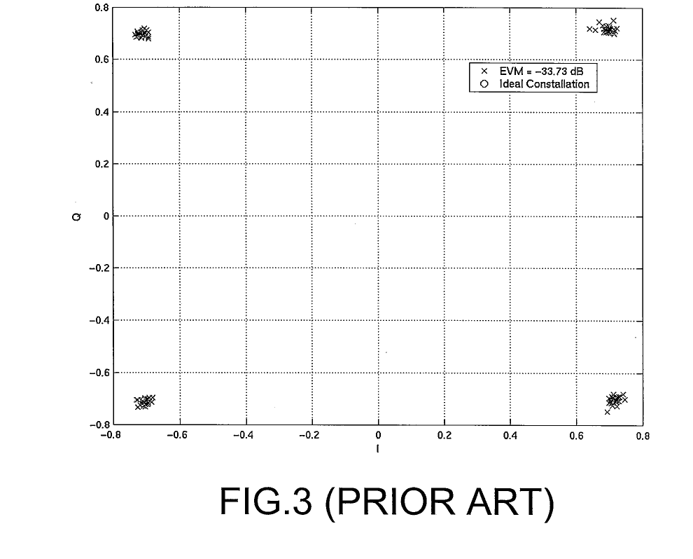

Ideal constellation of frequency-domain “CE” sequence is generated before IFFT. Before input to the IFFT module 115, the frequency-domain “CE” sequence is quantized into finite-number of bits. For considerations of reasonable implementation cost of IFFT, there are several quantization blocks in the IFFT module 115. Therefore, more quantization errors are introduced to the time-domain “CE” sequence after the IFFT module 115, due to the time-domain “CE” sequence is generated by the non-ideal IFFT module 115. EVM and constellation of “CE” by this conventional approach is −33.73 dB, which is shown in FIG. 3.

In EVM test, the EVM of transmitted packet is calculated by “channel estimation” and “frequency equalization” to calibrate the effects of channel impulse response. By calibration, the constellation of the input information bit IN can be applied for EVM calculation. Please refer to “WiMedia UWB PHY” for the details about calibration.

In WiMedia UWB PHY, there are two kinds of modulations: QPSK and Dual-Carrier Modulation (DCM). DCM have the similar constellation to 16-QAM (Quadrature Amplitude Modulation) but with different constellation mapping rule. For the constellation plot of QPSK, both the modulation schemes used in data sub-carrier and pilot sub-carriers are QPSK. For the constellation plot of DCM, the modulation scheme for data sub-carriers is DCM, while the modulation scheme for pilot sub-carriers is QPSK. In order to keep the same average powers for data sub-carriers and pilot sub-carriers, the ideal value of QPSK is located at one of the following 4 positions:

$$[ \frac{1}{\sqrt{2}} , \frac{1}{\sqrt{2}} ] , [ \frac{1}{\sqrt{2}} , - \frac{1}{\sqrt{2}} ] , [ - \frac{1}{\sqrt{2}} , \frac{1}{\sqrt{2}} ] , [ - \frac{1}{\sqrt{2}} , - \frac{1}{\sqrt{2}} ]$$

For DCM, the ideal value of 16-QAM is located at one of the following 16 positions:

$$[ \frac{1}{\sqrt{10}} , \frac{1}{\sqrt{10}} ] , [ \frac{1}{\sqrt{10}} , \frac{3}{\sqrt{10}} ] , [ \frac{3}{\sqrt{10}} , \frac{1}{\sqrt{10}} ] , [ \frac{3}{\sqrt{10}} , \frac{3}{\sqrt{10}} ] , \\ [ \frac{- 1}{\sqrt{10}} , \frac{1}{\sqrt{10}} ] , [ \frac{- 1}{\sqrt{10}} , \frac{3}{\sqrt{10}} ] , [ \frac{- 3}{\sqrt{10}} , \frac{1}{\sqrt{10}} ] , [ \frac{- 3}{\sqrt{10}} , \frac{3}{\sqrt{10}} ] , \\ [ \frac{1}{\sqrt{10}} , \frac{- 1}{\sqrt{10}} ] , [ \frac{1}{\sqrt{10}} , \frac{- 3}{\sqrt{10}} ] , [ \frac{3}{\sqrt{10}} , \frac{- 1}{\sqrt{10}} ] , [ \frac{3}{\sqrt{10}} , \frac{- 3}{\sqrt{10}} ] , \\ [ \frac{- 1}{\sqrt{10}} , \frac{- 1}{\sqrt{10}} ] , [ \frac{- 1}{\sqrt{10}} , \frac{- 3}{\sqrt{10}} ] , [ \frac{- 3}{\sqrt{10}} , \frac{- 1}{\sqrt{10}} ] , [ \frac{- 3}{\sqrt{10}} , \frac{- 3}{\sqrt{10}} ] ,$$

For implementation, the ideal constellation values in ideal values of QPSK and 16-QAM will be quantized into finite number bit number. For example, 6-bit signed number with 5-bit fractional part is assigned to implement the constellation of QPSK and DCM. Due to this quantization, quantization error is induced. However, the quantization errors for the values of QPSK and 16-QAM are not the same. Therefore, the average powers for “CE” sequence and pilot sub-carriers (modulated by QPSK) are not the same as data sub-carriers (modulated by DCM). Since the “channel estimation” is performed by “CE” sequence and the average power between “CE” sequence and data sub-carriers are not the same, the “frequency equalization” applied to data sub-carriers is not perfect. This non-ideal “frequency equalization” degrades EVM performance.

However, it's difficult to conquer this problem in the conventional frequency-domain CE generation because the non-ideal IFFT module 115 will degrade the performance of CE constellation.

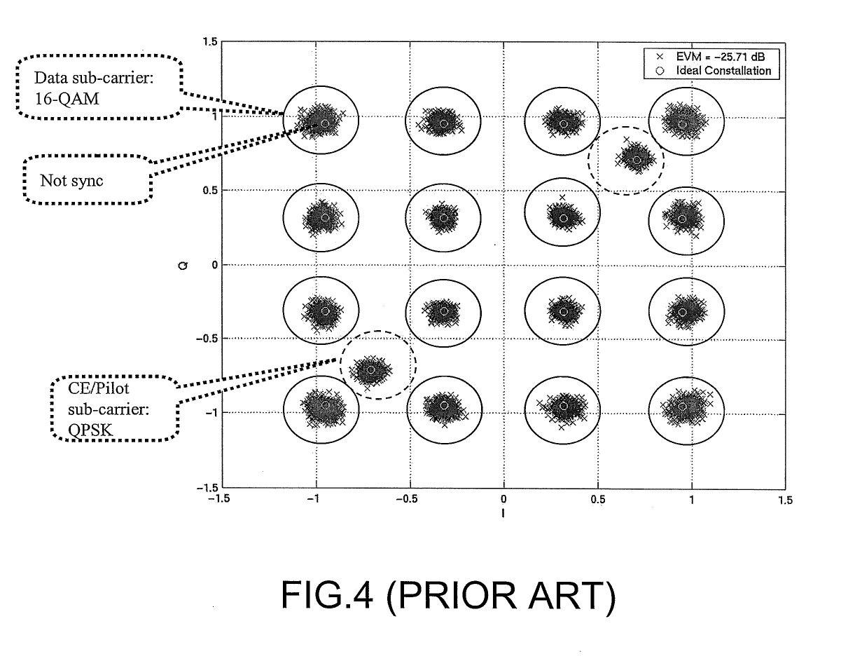

Another problem of frequency-domain CE generation is for DCM modulation. Due to the different quantization errors for QPSK and 16-QAM modulation schemes, EVM performance had been degraded. EVM performance had been degraded due to 16QAM constellation is not exactly compensated by equalization and further, due to the channel estimation is performed by the CE sequence, which is with different average power from data sub-carriers. This phenomenon can be observed from FIG. 4. FIG. 4 shows EVM and constellation for DCM modulation by the conventional approach. The EVM is −25.71 dB. In FIG. 4, the constellation circled by the solid line is for data sub-carrier while the constellation circled by the dotted line is for CE/Pilot carrier. As shown in FIG. 4, the constellation of QPSK (for pilot sub-carriers) is sync with the ideal QPSK modulation. However, the constellation of 16QAM (for data sub-carriers) is not sync with the ideal 16QAM modulation. Due to this mismatch, there are degradations in EVM.

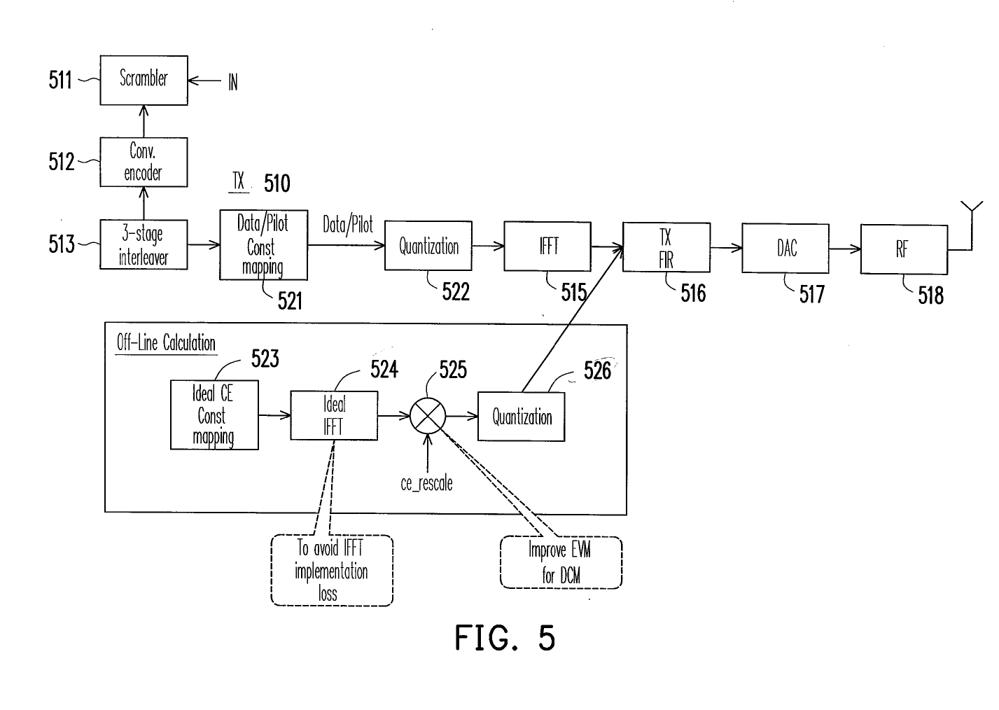

FIG. 5 shows a block diagram of a transmitter in the OFDM communication system according to an embodiment of the invention. The transmitter 510 includes a scrambler 511, a convolution encoder 512, a 3-stage interleaver 513, a data/pilot constellation mapping module 521, a quantization module 522, an IFFT module 515, a transmission FIR filter 516, a DAC 517, a RF module 518, an ideal CE constellation mapping module 523, an ideal IFFT module 524, a multiplier 525 and a quantization module 526.

The ideal CE constellation mapping module 523 generates a CE sequence in frequency domain. The generated frequency-domain CE sequence from the ideal CE constellation mapping module 523 is applied to the ideal IFFT module 524. The ideal IFFT module 524 transforms the frequency-domain CE sequence into time-domain CE sequence. The time-domain CE sequence from the ideal IFFT module 524 is multiplied by a predetermined coefficient “ce_rescale” by the multiplier 525. Before this time-domain “CE” sequence is applied to the TX FIR module 516, the quantization module 526 is applied. In the embodiment, the frequency-domain CE sequence generation (by the ideal CE constellation mapping module 523), the IFFT operation (by the ideal IFFT module 524), the multiplication with the coefficient “ce_rescale” (by the multiplier 525) and the quantization (by the quantization module 526) are done by off-line. That is to say, the time-domain CE sequence is pre-calculated. On the contrary, in convention, the CE constellation mapping (by the CE constellation mapping module 201) and quantization (by the quantization module 203) are done by on-line.

The ideal IFFT module 524 may avoid IFFT implementation loss. Besides, by CE rescaling (i.e. multiplication with the coefficient “ce_rescale”), the EVM for DCM is improved. That is because, by CE resealing, the mismatch of constellation of DCM is corrected for synchronizing the constellation of DCM well.

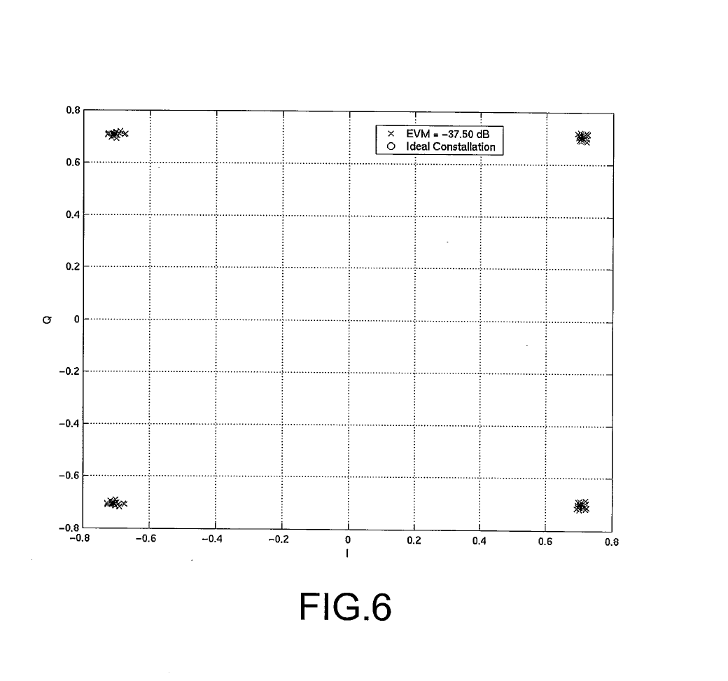

Due to this time-domain “CE” sequence is calculated by the ideal IFFT module 524, the EVM and constellation of this time-domain “CE” sequence is better than the conventional one. FIG. 6 shows EVM and constellation plot of the time-domain “CE” sequence according to the embodiment of the invention. As shown in FIG. 6, the EVM and constellation of this time-domain “CE” sequence is −37.50 dB under some exemplary conditions.

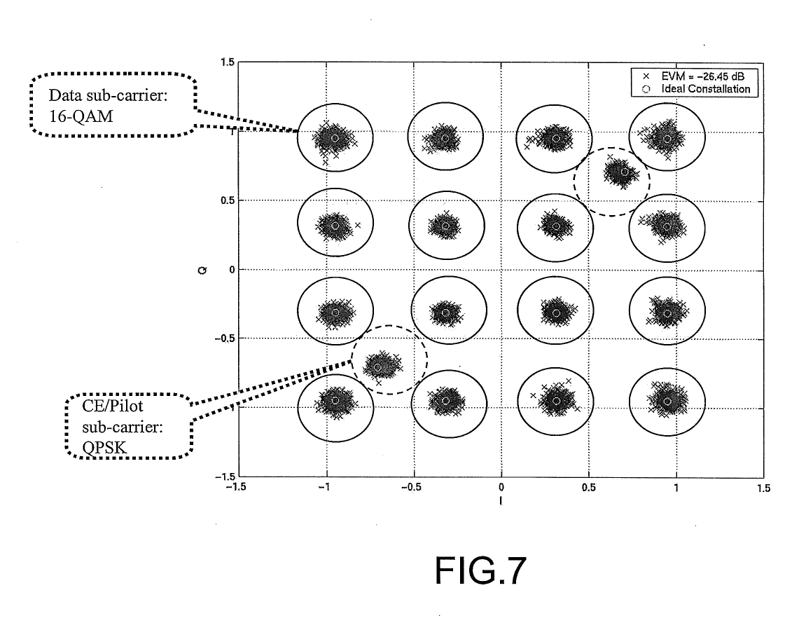

In the embodiment, the coefficient “ce_rescale” is applied to correct the mismatch of constellation of DCM. Under this condition, EVM is improved. FIG. 7 shows EVM and constellation plot of DCM by the time-domain “CE” sequence and resealing according to the embodiment of the invention. As shown in FIG. 7, the constellation of DCM is sync well.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A wireless communication method, comprising:
(a) modulating and generating a data/pilot constellation based on input information bits;
(b) off-line generating a channel estimation sequence in frequency-domain;
(c) off-line transforming the frequency-domain channel estimation sequence into a time-domain channel estimation sequence;
(d) based on a predetermined resealing coefficient, off-line resealing the time-domain channel estimation sequence; and
(e) off-line quantizing the time-domain channel estimation sequence.

2. The method of claim 1, wherein further comprising:
(f) quantizing the data/pilot constellation; and
(g) transforming the data/pilot constellation by an IFFT operation.

3. The method of claim 1, wherein the step (c) comprising:
(c1) transforming the frequency-domain channel estimation sequence into the time-domain channel estimation sequence by an ideal IFFT operation.

4. A transmitter for a communication system, comprising:
a channel estimation constellation mapping module, for off-line generating a channel estimation sequence in frequency-domain;
a first transforming module, for off-line and ideally transforming the frequency-domain channel estimation sequence from the channel estimation constellation mapping module into a time-domain channel estimation sequence;
a resealing module, for off-line resealing the time-domain channel estimation sequence from the first transforming module based on a predetermined resealing coefficient, for improving error vector magnitude (EVM) thereof; and
a first quantization module, for off-line quantizing the time-domain channel estimation sequence from the resealing module.

5. The transmitter of claim 4, further comprising:
a data/pilot constellation mapping module, for modulating and generating a data/pilot constellation;
a second quantization module, for quantizing the data/pilot constellation from the data/pilot constellation mapping module; and
a second transforming module, for transforming the data/pilot constellation output from the second quantization module.

6. The transmitter of claim 4, wherein the first transforming module comprises an ideal IFFT module.

7. The transmitter of claim 5, wherein the second transforming module comprises an IFFT module.

8. A communication system, comprising:
a data/pilot constellation mapping module, for modulating and generating a data/pilot constellation;
a first quantization module, for quantizing the data/pilot constellation from the data/pilot constellation mapping module;
a first transforming module, for transforming the data/pilot constellation output from the first quantization module;
a channel estimation constellation mapping module, for off-line generating a channel estimation sequence in frequency-domain;
a second transforming module, for off-line and ideally transforming the frequency-domain channel estimation sequence from the channel estimation constellation mapping module into a time-domain channel estimation sequence;
a resealing module, for off-line resealing, in time-domain, the time-domain channel estimation sequence from the second transforming module; and
a second quantization module, for off-line quantizing the time-domain channel estimation sequence from the resealing module.

9. The system of claim 8, wherein the first transforming module comprises an IFFT module.

10. The system of claim 8, wherein the second transforming module comprises an ideal IFFT module.

11. The system of claim 8, wherein the rescaling module rescales the time-domain channel estimation sequence from the second transforming module based on a predetermined resealing coefficient.
